(19) United States
(12) Patent Application Publication
(10) Pub. No.: US 2015/0146214 A1
(43) Pub. Date: May 28, 2015

(54) OPTICAL PERFORMANCE MEASUREMENT APPARATUS OF TEST OPTICAL ELEMENT AND ITS CONTROL UNIT

(71) Applicant: Canon Kabushiki Kaisha, Tokyo (JP)

(72) Inventor: Toshiyuki Naoi, Utsunomiya-shi (JP)

(21) Appl. No.: 14/547,601

(22) Filed: Nov. 19, 2014

(30) Foreign Application Priority Data
Nov. 28, 2013 (JP) 2013-245920

(51) Int. Cl. G01M 11/02

(52) U.S. Cl. CPC G01M 11/0271
USPC 356/521

(57) ABSTRACT

A measuring apparatus measures an optical performance of a test optical element and includes a diffraction grating configured to emit diffracted light, an image sensor configured to capture an interference pattern formed by the diffracted light, and a controller configured to move the at least one of the diffraction grating and the image sensor in an optical axis direction, to capture a plurality of interference patterns before and after movements, and to calculate a light-condensing position based on a spatial frequency of a plurality of interference patterns and a moving amount.

### BACKGROUND OF THE INVENTION

1. Field of the Invention

The present invention relates to a measuring apparatus of an optical performance such as a transmitted wavefront and a refractive index distribution, of a test optical element, such as a lens and a plane-parallel plate.

2. Description of the Related Art

A transmitted wavefront measuring apparatus of a lens and a refractive index distribution measuring apparatus of a lens may use an illumination optical system configured to emit an ideal spherical wave so as to increase a measureable lens type, and a positional relationship becomes important between a light-condensing position of the illumination optical system and a detector. In particular, when the illumination optical system has a high numerical aperture (“NA”), the illumination optical system and the light-condensing position are close to each other and thus it is difficult for arrangement purposes to directly measure the light-condensing position and to recognize a positional relationship between the light-condensing position and the detector. In this case, the positional relationship between the light-condensing position of the illumination optical system and the detector are measured at the defocus position. Some methods are known for measuring the positional relationship between the light-condensing position of the illumination optical system and the detector at the defocus position, such as a method for measuring a distance between a first diffraction grating and a light-condensing position from a moiré pattern (Japanese Patent Laid-Open No. (“JP”) 60-247133), and a method for calculating a focusing component of a wavefront (JP2010-223903).

The moiré measuring method disclosed in JP 60-247133 requires a second diffraction grating and an imaging lens, and it is difficult to highly measure a slope of the diffraction grating and a slope of the moiré pattern. The wavefront measuring method disclosed in JP 2010-223903 arduously requires a previous and precise measurement of a spatial frequency of a diffraction grating.

### SUMMARY OF THE INVENTION

The present invention provides a measuring apparatus and its control unit, which can comparatively easily and precisely measure a positional relationship between a light-condensing position of an illumination optical system and a detector.

A measuring apparatus according to the present invention is configured to measure an optical performance of a test optical element. The measuring apparatus includes an illumination optical system configured to emit light of a spherical wave, a diffraction grating configured to emit diffracted light based on the light from the illumination optical system, an image sensor configured to capture an interference pattern formed by the diffracted light, a moving unit configured to move at least one of the diffraction grating and the image sensor in an optical axis direction of the illumination optical system, and a controller configured to control the moving unit so as to move the at least one of the diffraction grating and the image sensor in the optical axis direction, to control the image sensor so as to capture a plurality of interference patterns before and after movements, and to calculate a light-condensing position of the illumination optical system based on a spatial frequency of a plurality of interference patterns and a moving amount of the at least one of the diffraction grating and the image sensor by the moving unit.

Further features of the present invention will become apparent from the following description of exemplary embodiments with reference to the attached drawings.

### BRIEF DESCRIPTION OF THE DRAWINGS

FIG. 1 is a block diagram of a transmitted wavefront measuring apparatus according to a first embodiment of the present invention.

FIG. 2 is a flowchart of a transmitted wavefront measuring method executed by a calculator illustrated in FIG. 1 according to the first embodiment.

FIG. 3 is a detailed flowchart of S101 illustrated in FIG. 2 according to the first embodiment.

FIG. 4 is an explanatory view of a calculating method of a fundamental frequency of an interference pattern in S14 illustrated in FIG. 3 according to the first embodiment.

FIG. 5 is a block diagram of a transmitted wavefront measuring apparatus according to a second embodiment of the present invention.

FIG. 6 is a flowchart of a transmitted wavefront measuring method executed by a calculator illustrated in FIG. 5 according to the second embodiment.

FIG. 7 is a block diagram of a measuring apparatus configured to measure a spatial frequency of a diffraction grating according to a third embodiment.

FIG. 8 is a flowchart for measuring a positional relationship between a light-condensing position of an illumination optical system and a detector according to the third embodiment.

### DESCRIPTION OF THE EMBODIMENTS

A measuring apparatus according to this embodiment measures the optical performance, such as a transmitted wavefront and a refractive index distribution, of a test optical element, such as a lens and a plane-parallel plate, and comparatively easily measures a light-condensing position S of an illumination optical system configured to emit light of an ideal spherical wave and to illuminate the test optical element. A description will now be given of embodiments of the present invention.

### First Embodiment

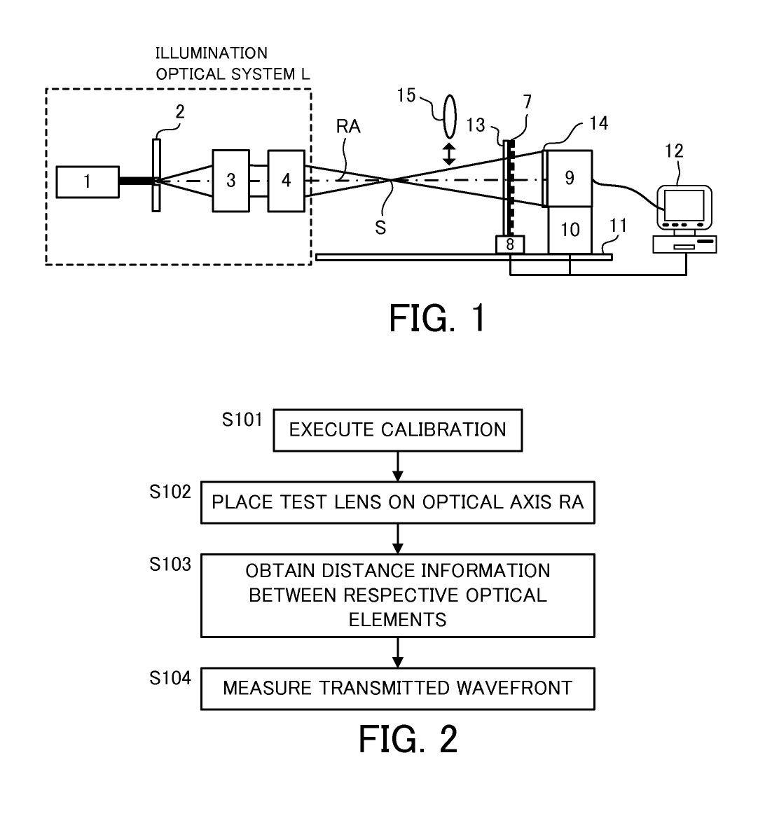

FIG. 1 is a block diagram of a transmitted wavefront measuring apparatus according to the first embodiment. The transmitted wavefront measuring apparatus measures a transmitted wavefront of a test lens (test optical element) 15, and includes an illumination optical system L, a diffraction grating 7, a detector 9, driving units 8 and 10, a rail 11, a calculator 12, a substrate glass 13, and a cover glass 14.

The illumination optical system L includes a light source 1, such as a laser, a pinhole plate 2 having a sufficient small aperture, a first collimator lens 3, and a second collimator lens 4, and emits an ideal convergent spherical wave (light of an ideal spherical wave). The light flux emitted from the illumination optical system L condenses on a light-condensing position S.

The diffraction grating 7 and the detector 9 are arranged on the downstream stage of the illumination optical system L. The diffraction grating 7 emits the diffracted light using the light from the illumination optical system L, and the diffracted light fluxes interfere each other and form an interference pattern. The diffraction grating 7 can use a transmission-type diffraction grating, such as a square grating having periods in two orthogonal directions, and has a known thickness and a known refractive index of the substrate glass (transmitting member) 13. The design period value of the diffraction grating 7 is used to determine a measurement arrangement. The measuring precision is not affected even when the period of the actual diffraction grating 7 shifts from the designed period value. The detector 9 is an image sensor configured to capture an interference pattern formed by the diffracted light, and may use a CCD, for example. The detector 9 includes the cover glass (transmitting unit) 14 that has a known thickness and a known refractive index.

The diffraction grating 7 includes a driving unit 8, and the detector 9 includes a driving unit 10. The diffraction grating 7 and the detector 9 are configured to move along the rail 11 installed parallel to an optical axis RA of the illumination optical system L. The diffraction grating 7 and the detector 9 may be arranged on the upstream or downstream side of the light-condensing position S. The driving units 8 and 10 and the rail 11 constitute a moving unit configured to move the diffraction grating 7 and the detector 9 in the optical axis direction of the illumination optical system L. It is sufficient for the moving unit to move at least one of the diffraction grating 7 and the detector 9 in the optical axis direction of the illumination optical system L.

The calculator 12 is comprised by a personal computer (“PC”) and serves as a controller (control unit) configured to control a movement by the moving unit and image pickup by the detector 9. The calculator 12 calculates a distance between the light-condensing position S of the illumination optical system L and the detector 9 based on the interference pattern obtained by the detector 9 and the moving amount(s) of at least one of the diffraction grating 7 and the detector 9. The test lens 15 can be positioned on the optical axis RA between the illumination optical system L and the diffraction grating 7, and can be retreated from the optical axis RA of the illumination optical system L via a moving unit (not illustrated) in measuring the distance between the light-condensing position S and the detector 9. When the test lens 15 is arranged on the optical axis RA, the calculator 12 can calculate the transmitted wavefront of the test lens 15 based on the interference patterns obtained by the detector 9.

FIG. 2 is a flowchart of a transmitted wavefront measuring method (control method) performed by the calculator 12, and “S” stands for the step. The flowchart illustrated in FIG. 2 can be implemented as a program that enables a computer to execute the function of each step. This is true of other flowcharts. The program can be stored in the non-transitory computer-readable medium.

In S101 (calibration), the calculator 12 measures a distance between the light-condensing position S and the detector 9. When each of the driving units 8 and 10 has good reproducibility, S101 does not have to be performed for each measurement. It may be performed when the measuring apparatus is powered on and when the collimator lens is replaced. In S101, the light-condensing position S is measured as described later.

In S102, the calculator 12 automatically or a user manually installs the test lens 15 on the optical axis RA. In S103, a distance between the test lens 15 and the diffraction grating 7 and a distance between the diffraction grating 7 and the detector 9 are measured so as to obtain a position of each optical element relative to the light-condensing position S. In S104, the transmitted wavefront of the test lens 15 is measured.

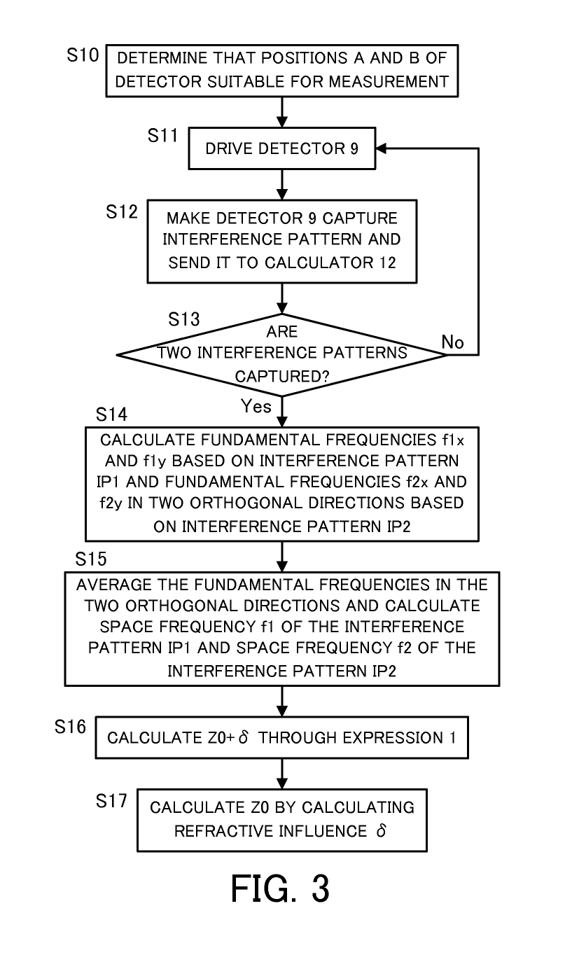

FIG. 3 is a detailed flowchart of S101. Assume that the test lens 15 is removed from the optical axis RA of the illumination optical system L in S101.

Initially, in S10, positions A and B of the detector 9 suitable for the measurement are determined based on the designed period value of the diffraction grating 7. The positions A and B are determined based on a position C that provides a Talbot distance n·d²/λ to the distance between the diffraction grating 7 and the detector 9 where d is a designed period value of the diffraction grating, λ is a wavelength of the light source, and n is an integer. The interference patterns IP1 and IP2 may have the same or different values of n. When they have the same value of n, the positions A and B are arranged on both sides of the position C so as to sandwich the position C. The positions A and B may not provide the Talbot distance, as long as they are used to detect the primary spectrum of the interference pattern.

In S11, the driving unit 10 moves the detector 9 to the position A. In S12, the detector 9 captures the interference pattern IP1, and sends the information of the interference pattern IP1 to the calculator 12. In S13, the driving unit 10 moves the detector 9 to the position B in the optical axis RA direction by a moving amount dZ0, and the detector 9 captures the interference pattern IP2 and sends the information of the interference pattern IP2 to the calculator 12.

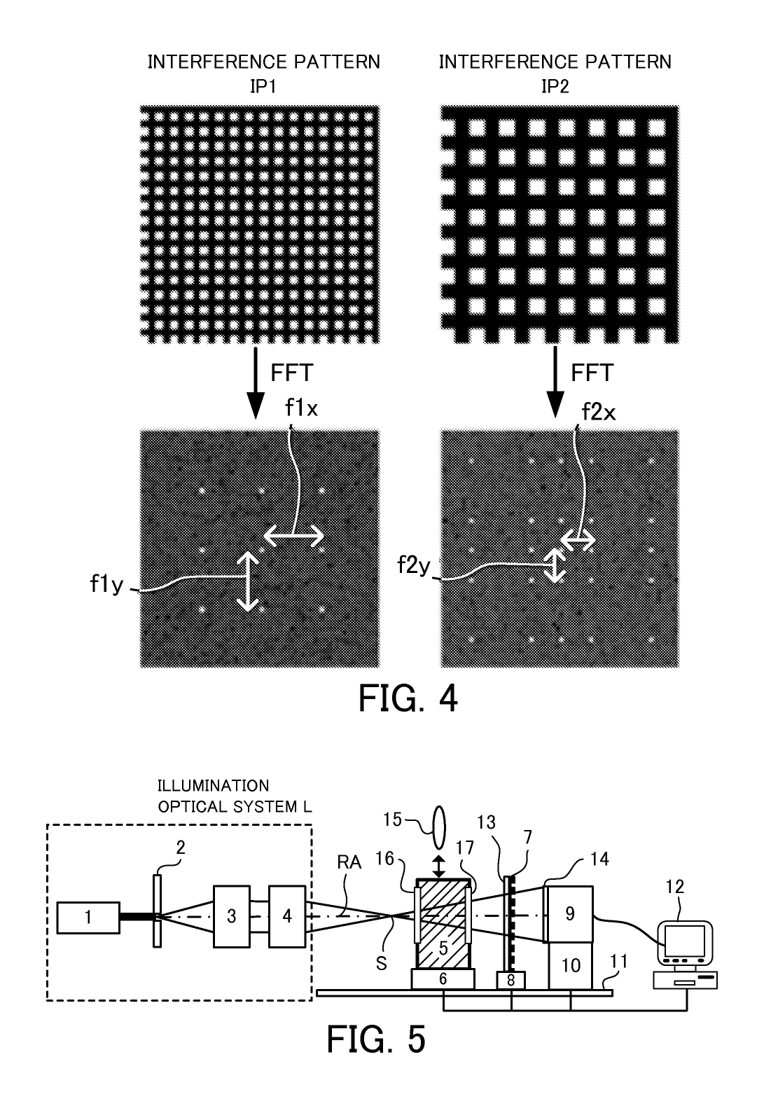

In S14, the calculator 12 calculates the fundamental frequencies f1x and f1y based on the interference pattern IP1, and f2x and f1y in the two orthogonal directions based on the interference pattern IP2. The fundamental frequency is used to convert the interference pattern into a two-dimensional Fourier transform, and to obtain the spectrum coordinates of a plurality of diffracted light fluxes (which are herein the 0-th order light and the n-th order light). Herein, the spectrum coordinates of the 0-th order light and the n-th order light are obtained and set to a distance between these two points in the spectrum space. When the interference pattern spreads over the entire screen, the peripheral signal intensity is reduced by applying the intensity filter. The coordinate of the n-th spectrum is calculated by extracting the maximum value of the periphery of the n-th spectrum intensity and by calculating the center of gravity. FIG. 4 is a schematic view used to calculate the fundamental frequencies f1x and f1y, f2x and f1y based on the 0-th order spectrum and the 1^{st} order spectrum.

In S15, the calculator 12 averages the fundamental frequencies in two orthogonal directions, and calculates the spatial frequency f1 of the interference pattern IP1 and the spatial frequency f2 of the interference pattern IP2 based on the average values. The present invention is not limited to the simple average, and may use the weighted average. The average value of the fundamental frequencies in two orthogonal directions can reduce the influence of the astigmatism generated in the illumination optical system L, the substrate glass 13, and the cover glass 14.

In S16, the calculator 12 calculates Z0+δ through Expression 1, where Z0 is a distance between the light-condensing position S and the detector 9 that is located at the position A, and δ represents the refractive influence of the substrate glass 13 and the cover glass 14.

$$\begin{matrix}Expression 1 & \\ Z 0 + δ \text{:} Z 0 + δ + d Z 0 = \frac{1}{f 1} : \frac{1}{f 2} \\ Z 0 + δ = \frac{f 2}{f 1 - f 2} dZ 0 & ( 1 )\end{matrix}$$

In S17, the calculator 12 calculates Z0 through Expression 2 (this correction is made by removing δ from Z0+δ).

$$\begin{matrix}Expression 2 & \\ δ = {t}_{13} \frac{tan θ - tan {θ}_{13}}{tan θ} + {t}_{14} \frac{tan θ - tan {θ}_{14}}{tan θ} \\ sin θ = {n}_{13} sin {θ}_{13} + {n}_{14} sin {θ}_{14} & ( 2 )\end{matrix}$$

Herein, n₁₃ is a refractive index of the substrate glass 13, n₁₄ is a refractive index of the cover glass 14, t₁₃ is a thickness of the substrate glass 13, and t₁₄ is a thickness of the cover glass 14. θ is an angle of a ray that propagates in air, θ₁₃ is an angle of a ray that propagates the substrate glass 13, and θ₁₄ is an angle of a ray that propagates the cover glass 14. θ, θ₁₃, and θ₁₄ are angles to the optical axis RA. The precision of this approach can be calculated by Expression 3.

$$\begin{matrix}Expression 3 & \\ δ Z 0 = \frac{1}{f 1 - f 2} \sqrt{{( \frac{f 2}{f 1 - f 2} d Z 0 )}^{2} δ f {1}^{2} + {( \frac{f 1}{f 1 - f 2} d Z 0 )}^{2} δ f {2}^{2} + f {2}^{2} δ d Z {0}^{2}} & ( 3 )\end{matrix}$$

Herein, δf1 represents the uncertainty of f1, δf2 represents the uncertainty of f2, δdZ0 represents the uncertainty of dZ0. When an actually applicable value is substituted for each parameter so as to realize an arrangement, such as δf1=δf2=1/200, δdZ0=1 μm, and Z0=43 mm, the precision can be estimated as about 10 μm.

The calculator 12 controls the moving unit so as to move at least one of the diffraction grating 7 and the detector 9 in the optical axis direction, and controls the detector 9 so as to capture a plurality of interference pattern before and after the movement, and calculates the light-condensing position S based on the moving amount by the moving unit and the spatial frequency of the plurality of interference patterns. Instead of moving the detector 9 as in this embodiment, the diffraction grating 7 may be moved.

In this case, the following expression is used instead of the above expression.

$$\begin{matrix}Expression 4 & \\ Z 0 + δ = \frac{fg}{f 2 - f 1} dZ g & ( 4 )\end{matrix}$$

Herein, dZg denotes a driving amount of the diffraction grating 7, fg denotes a special frequency of the diffraction grating 7, f1 denotes a spatial frequency of the interference patterns before the diffraction grating 7 is moved, and f2 denotes a spatial frequency of the interference patterns after the diffraction grating 7 is moved.

Alternatively, both the diffraction rating 7 and the detector 9 may be moved. In this case, the following expression is used instead of the above expression.

$$\begin{matrix}Expression 5 & \\ Z 0 + δ = \frac{f g}{f 2 - f 1} dZ g + \frac{f 2}{f 1 - f 2} d Z 0 & ( 5 )\end{matrix}$$

Herein, f1 is a spatial frequency of interference patterns before the diffraction grating 7 and the detector 9 are moved, and f2 is a spatial frequency of the interference pattern after the diffraction grating 7 and the detector 9 are moved.

### Second Embodiment

FIG. 5 is a block diagram of a refractive index distribution measuring apparatus. Those elements in FIG. 5, which are corresponding elements in FIG. 1, will be designated by the same reference numerals. The refractive index distribution measuring apparatus measures a transmitted wavefront by immersing the test lens into each of two types of media having different refractive indices, and calculates an internal refractive index distribution of the test lens. The refractive index distribution measuring apparatus includes an illumination optical system L, a bath 5, a diffraction grating 7, a detector 9, driving units 6, 8, and 10, a rail 11, a calculator 12, a substrate glass 13, and a cover glass 14. The calculator 12 executes the refractive index distribution measuring method.

When the present invention is applied to the refractive index distribution measuring method, the bath 5 configured to house the test lens 15 is added to a space on the optical axis RA between the illumination optical system L and the diffraction grating 7. In the bath 5, the thickness and the refractive index of each of a front window glass 16 and a rear window glass 17 are known, and the distance between the front window glass 16 and the rear window glass 17 are also known. The bath 5 houses a medium 18 having a known refractive index. The bath 5 includes the driving unit 6, the diffraction grating 7 includes the driving unit 8, and the detector 9 includes the driving unit 10, respectively, and the bath 5, the diffraction grating 7, and the detector 9 are configured to move along the rail 11 that is installed parallel to the optical axis RA of the illumination optical system L.

The calculator 12 can calculate a distance between the light-condensing position S of the illumination optical system L and the detector 9 based on driving amounts by the driving units 8 and 10 and the interference patterns obtained by the detector 9. The test lens 15 can be positioned on the optical axis RA in the medium 18, and can be removed from the optical axis RA of the illumination optical system L in measuring the distance between the light-condensing position S and the detector 9. When the test lens 15 is arranged on the optical axis RA in the medium 18, can be removed from the optical axis RA of the illumination optical system L. The calculator 12 can calculate the refractive index distribution of the test lens 15 based on the interference patterns obtained by the detector 9, once the test lens 15 is arranged on the optical axis RA in the medium 18.

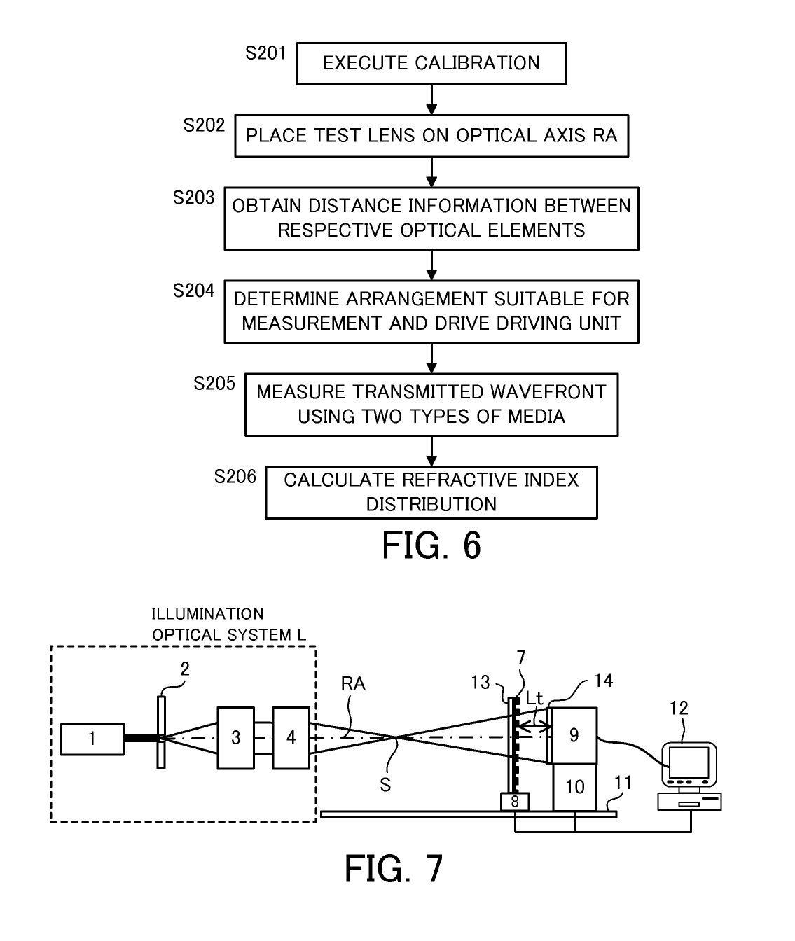

FIG. 6 is a flowchart of a refractive index distribution measuring method executed by the calculator 12.

In S201 (calibration), the calculator 12 measures a distance between the light-condensing position S and the detector 9. When each of the driving units 8 and 10 have good reproducibility, S201 does not have to be performed for each measurement, and may be performed when the measuring apparatus is powered on and in the regular inspection. The details of S201 will be described later.

In S202, the test lens 15 is installed on the optical axis RA in the bath 5. In S203, the calculator 12 measures a distance between the test lens 15 and the bath 5, a distance between the bath 5 and the diffraction grating 7, and a distance between the diffraction grating 7 and the detector 9, and obtains the position of each optical element relative to the light-condensing position S. In S204, the calculator 12 calculates the component arrangement suitable for the measurement of the refractive index distribution, and controls driving of the driving units 6, 8, and 10.

In S205, the calculator 12 calculates the transmitted wavefront with two types of media having different refractive indices. In S206, the calculator 12 immerses the test lens 15 into each of the two types of media having different refractive indices, obtains the measurement result of the transmitted wavefront, and calculates an internal refractive index distribution of the test lens 15. The refractive index distribution GI is calculated through Expression 6, where N₀ denotes a refractive index of the test lens 15, N₁ denotes a refractive index of a first medium, N₂ denotes a refractive index of a second medium, W1 is a transmitted wavefront of the first medium, W2 is a transmitted wavefront of the second medium, and D is a thickness of the test lens 15 in the optical axis direction.

$$\begin{matrix}Expression 6 & \\ GI = \frac{( {N}_{0} - {N}_{1} ) W 2 - ( {N}_{0} - {N}_{2} ) W 1}{{N}_{2} - {N}_{1}} \times \frac{1}{D} & ( 6 )\end{matrix}$$

While the method using two types of media has been described, the transmitted wavefront of the test lens 15 may be measured with two types of light fluxes having different wavelengths while the test lens 15 is immersed in a medium having a refractive index dispersion different from that of the test lens 15 and then the refractive index distribution of the test lens 15 may be calculated. In this case, the illumination optical system L serves to selectively emit each of the two types of light fluxes.

The illustrative procedure of S201 follows FIG. 3. The bath 5 is previously moved by the driving unit 6 so that it does not mechanically interfere with the diffraction grating 7 or the detector 9. S10 to S16 are similar to those in the method described in the first embodiment. In S17, the calculator 12 calculates Z0 through Expression 7. In the refractive index measuring apparatus, the refractive influences of the window glasses of the bath 5 and the medium 18 are considered in addition to the refractive influences of the substrate glass 13 and the cover glass 14.

$$\begin{matrix}Expression 7 & \\ δ = {\sum }_{i} {t}_{i} \frac{tan θ - tan {θ}_{i}^{′}}{tan θ} \\ sin θ = {n}_{i} sin {θ}_{i}^{′} & ( 7 )\end{matrix}$$

Herein, a reference numeral of a component in FIG. 3, such as 13 (substrate glass 13), 14 (cover glass 14), 16 (front window glass 16), 17 (rear window glass 17), and 18 (medium 18), is substituted for i. nᵢ denotes a refractive index of the component i, and tᵢ denotes a thickness of the component i. θ denotes an angle of a ray that propagates in air, and θᵢ′ is an angle of a ray that propagates in the component i. θ and θᵢ′ are angles relative to the optical axis RA.

The method of this embodiment is effective when it is mechanically difficult to introduce a new component because the illumination optical system L, the bath 5, and the detector 9 are close to each other when the exit NA of the illumination optical system L is so high that the light-condensing position S is close to the illumination optical system L. The method of this embodiment enables S201 to be executed near the transmitted wavefront measuring position, and the refractive index distribution measuring apparatus is less affected by the specific arrangement. The refractive index distribution measuring apparatus can improve the measurement precision by using this method.

### Third Embodiment

FIG. 7 is a block diagram of a measuring apparatus according to a third embodiment. The measuring apparatus measures a spatial frequency of the diffraction grating and includes, similar to FIG. 1, an illumination optical system L, a diffraction grating 7, a detector 9, driving units 8 and 10, a rail 11, a calculator 12, a substrate glass 13, and a cover glass 14.

The illumination optical system L emits an ideal converged spherical wave, similar to the first embodiment, and the emitted light flux is condensed on the light-condensing position S. The diffraction grating 7 and the detector 9 are arranged on the downstream side of the illumination optical system L. A distance Lt between the diffraction grating 7 and the detector 9 in the optical direction is separately measured and thus known. The interference patterns are captured with the diffraction grating 7, the detector 9, the driving units 8 and 10 that are similar to those of the first embodiment. The calculator 12 can calculate a distance between the light-condensing position S of the illumination optical system L and the detector 9, similar to the first embodiment.

The spatial frequency of the diffraction grating can be calculated with the spatial frequency of the interference patterns and the distance Lt. The test lens 15 can be removed from the optical axis RA of the illumination optical system L during the measurement, similarly to the first embodiment. When the test lens 15 is arranged on the optical axis RA, the calculator 12 can calculate the transmitted wavefront of the test lens based on the interference pattern obtained by the detector 9.

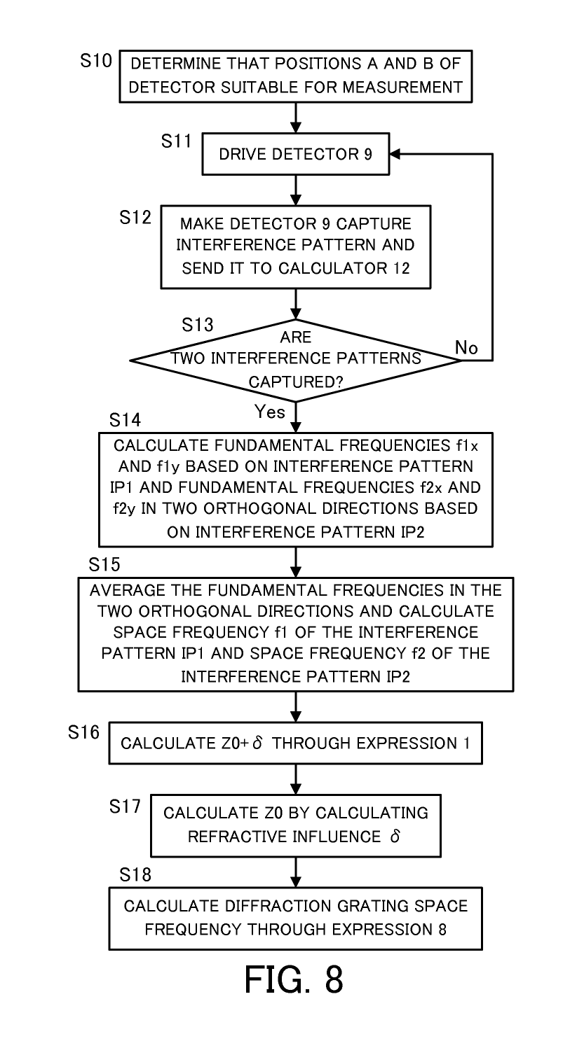

FIG. 8 is a flowchart of the measuring method configured to measure the spatial frequency of the diffraction rating according to the third embodiment, and those steps in FIG. 8, which are corresponding elements in FIG. 3, will be designated by the same reference numerals. S10 to S17 are used to calculate f1, f2, and Z0. In S18, the calculator 12 calculates the spatial frequency f of the diffraction grating 7 through Expression 8.

$$\begin{matrix}Expression 8 & \\ f = \frac{Z 0}{Z 0 - {L}_{t}} f 1 & ( 8 )\end{matrix}$$

Each of the above embodiments can provide a measuring apparatus and its control unit, which can comparatively easily and precisely measure a positional relationship between a light-condensing position of an illumination optical system and a detector.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-245920, filed Nov. 28, 2013, which is hereby incorporated by reference herein in its entirety.

What is claimed is:

1. A measuring apparatus configured to measure an optical performance of a test optical element, the measuring apparatus comprising:
an illumination optical system configured to emit light of a spherical wave;
a diffraction grating configured to emit diffracted light based on the light from the illumination optical system;
an image sensor configured to capture an interference pattern formed by the diffracted light;
a moving unit configured to move at least one of the diffraction grating and the image sensor in an optical axis direction of the illumination optical system; and
a controller configured to control the moving unit so as to move the at least one of the diffraction grating and the image sensor in the optical axis direction, to control the image sensor so as to capture a plurality of interference patterns before and after movements, and to calculate a light-condensing position of the illumination optical system based on a spatial frequency of a plurality of interference patterns and a moving amount of the at least one of the diffraction grating and the image sensor by the moving unit.

2. The measuring apparatus according to claim 1, wherein the controller calculates a transmitted wavefront of the test optical element based on the interference patterns obtained by the image sensor by arranging the test optical element on an optical axis of the illumination optical system.

3. The measuring apparatus according to claim 1, further comprising a bath configured to house a medium having a known refractive index, through which the light from the illumination optical system can transmit,
wherein the controller calculates a transmitted wavefront of the test optical element based on the interference patterns obtained by the image sensor by arranging the test optical element on the optical axis of the illumination optical system in the bath, and calculates a refractive index distribution of the test optical element based on the transmitted wavefront of the test optical element.

4. The measuring apparatus according to claim 3, wherein the controller calculates a transmitted wavefront of the test optical element based on the interference patterns obtained by the image sensor by immersing the test optical element in each of two types of media having different refractive indices, and calculates a refractive index distribution of the test optical element based on the transmitted wavefront of the test optical element.

5. The measuring apparatus according to claim 3, wherein the illumination optical system selectively emits one of two types of light fluxes having different wavelengths, and
wherein the controller calculates a transmitted wavefront of the test optical element based on the interference patterns obtained by the image sensor for each of the two types of the light fluxes by immersing the test optical element in a medium having a refractive index dispersion from that of the test optical element, and calculates a refractive index distribution of the test optical element based on the transmitted wavefront of the test optical element.

6. The measuring apparatus according to claim 1, further comprising a transmitting unit having a known thickness and a known refractive index, through which the light from the illumination optical system transmits,
wherein the controller corrects the light-condensing position based on the known thickness and the known refractive index of the transmitting unit.

7. The measuring apparatus according to claim 1, wherein the diffraction grating has a square grating having periods in two orthogonal directions, and
wherein the controller calculates spatial frequencies in two orthogonal directions of the plurality of interference patterns, and calculates the light-condensing position based on an average value of the spatial frequencies in the two orthogonal directions.

8. The measuring apparatus according to claim 1, wherein the controller calculates the light-condensing position by removing the test optical element from an optical axis of the illumination optical system.

9. The measuring apparatus according to claim 1, wherein the controller calculates the spatial frequency of the diffraction grating using the light-condensing position of the illumination optical system and a distance between the diffraction grating and the image sensor in the optical axis direction.

10. A control unit used for a measuring apparatus that is configured to measure an optical performance of a test optical element and includes an illumination optical system configured to emit light of a spherical wave, a diffraction grating configured to emit diffracted light using the light from the illumination optical system, an image sensor configured to capture an interference pattern formed by the diffracted light, and a moving unit configured to move at least one of the diffraction grating and the image sensor in an optical axis direction of the illumination optical system,
wherein the control unit is configured to control the moving unit so as to move the at least one of the diffraction grating and the image sensor in the optical axis direction, to control the image sensor so as to capture a plurality of interference patterns before and after movements, and to calculate a light-condensing position of the illumination optical system based on a spatial frequency of a plurality of interference patterns and a moving amount of the at least one of the diffraction grating and the image sensor by the moving unit.

11. A control method used for a measuring apparatus that is configured to measure an optical performance of a test optical element and includes an illumination optical system configured to emit light of a spherical wave, a diffraction grating configured to emit diffracted light using the light from the illumination optical system, an image sensor configured to capture an interference pattern formed by the diffracted light, and a moving unit configured to move at least one of the diffraction grating and the image sensor in an optical axis direction of the illumination optical system, the control method comprising the steps of:
controlling the moving unit so as to move the at least one of the diffraction grating and the image sensor in the optical axis direction;
controlling the image sensor so as to capture a plurality of interference patterns before and after movements; and
calculating a light-condensing position of the illumination optical system based on a spatial frequency of a plurality of interference patterns and a moving amount of the at least one of the diffraction grating and the image sensor by the moving unit.
